(19) United States
(12) Patent Application Publication
(10) Pub. No.: US 2004/0148573 A1
(43) Pub. Date: Jul. 29, 2004

(54) Apparatus and method for creation and exchange of data fields

(76) Inventors: Steve Buice, San Diego, CA (US); Kayvan Farzin, San Diego, CA (US)

Correspondence Address: Eastman & Associates, Suite 1800, 707 Broadway Street, San Diego, CA, 92101, US

(21) Appl. No.: 10/756,867

(22) Filed: Jan. 13, 2004

Related U.S. Application Data
(60) Provisional application No. 60/439,423, filed on Jan. 13, 2003.

(51) Int. Cl. G06F 17/21

(52) U.S. Cl. 715/517

(57) ABSTRACT

An apparatus and method for the creation and exchange of data fields includes a server, a customer computer, and a client computer all connected via the Internet. Data, such as a electronic postcard, photo-message, or collection of data fields may be exchanged. The present invention allows for a user to arrange the creation, transmission and display of these messages which may include multiple digital images that automatically appear in repeating succession along with multiple text messages and music and/or voice data. The images, text, and voice and/or music may uploaded into a host computer network and inserted into custom E-mail templates for storage on the host computer and transmission to one or more recipients identified by the user.

### RELATED APPLICATION

The present application claims the benefit of priority to U.S. Provisional Patent Application Serial No. 60/439,423, entitled “Real-T-Mail Photo-Message” filed Jan. 13, 2003 and currently copending.

### FIELD OF THE INVENTION

The present invention relates generally to data transmission devices for exchanging and routing information over a global computer network. The present invention is particularly, though not exclusively, suited to create and disseminate data, including text, sound, and image data, to a collection of predetermined recipients. The present invention is perhaps most useful to facilitate the dissemination of text, sound, and image data related to real property transactions and related activities over a global computer network to a collection of specified recipients.

### BACKGROUND OF THE INVENTION

With the popularization of the global computer network (the Internet), it has become common to utilize the Internet as a means to disseminate information. Unfortunately, people and organizations that send bulk electronic mail (“E-mail”) messages (often called “spam”) to users without their request or permission have caused the internet advertising industry harm. Specifically, in the past few years, legislation has been underway to severely limit the types and amount of Internet advertising that can be sent, and may require a recipient to “opt in” to a mailing list.

In contrast to the traditional mass, or bulk, E-mail approach to advertising and promotion of a business, many companies have begun to develop their own, proprietary database of interested consumers, and past customers. Often, it is the intention of the company to disseminate advertising or promotional materials to their interested consumers and/or customers via the Internet. This dissemination is often done via E-mail.

Unfortunately, the presently available technology of available E-mail programs only allows a user to insert a single image into a template that must typically be accessed by going to a specific web-site, using POTS (plain old telephone service), and a server system such as the Internet.

Devices for image insertion into an E-mail message have slowly evolved and some basic template applications are used on commercial sites. However, even these templates do not provide for the rotation or sequencing of multiple images that have been identified and selected solely by the user sending the message, along with custom voice, music, a web link and also an E-mail contact button.

The Real Estate business has continued to use archaic communication methods for distributing photographic images. Handing out photos at the home or mailing the photos is just not an efficient method of informing literally thousands of other Realtors®. Some Realtors® do send out photos via the web, but they are simply received as attachments, which many people refuse to open. Web-sites are good for those who come and visit a web address. However consumers must take affirmative steps to find and go to that web address. In addition, Realtors® continue to try and reach potential purchasers or other real estate professionals by conventional newspaper ads, phone calls or physical visits, which are all very time consuming.

In light of the above, it would be advantageous to provide an apparatus and method for the creation and exchange of data fields for use in the real estate industry that is easy to use, comparatively cost effective, and provides the real estate professional with an effective means of assembling and disseminating information related to their business to colleagues, and prospective and current customers.

### SUMMARY OF THE INVENTION

The present invention includes an apparatus and method for the creation and exchange of data fields. The present invention allows for a user to arrange the creation, transmission and display of messages over a global computer network, such as the Internet. The messages may include multiple digital images, such as digitized photographs, that automatically appear in repeating succession along with multiple text messages and music and/or voice data. The images, text, and voice and/or music is uploaded by a user into a host computer network and inserted into custom E-mail templates for storage on the host computer. These templates are held on the host server and are distributed via the Internet to recipients identified by the user. The users' personal photograph and individualized contact information is also embedded to any referral's computer automatically via the Internet and is changeable daily.

The apparatus and method for the creation and exchange of data fields of the present invention allows consumers to insert multiple digital images, such as photos that they own, have acquired, copied or have taken themselves, into a pre-determined area of multiple templates that have been created and are available on the server and/or host computer's web address (such as real-t-mail.com). An additional web-link and E-mail contact button is also included with changeable text onto this template. These represent direct, or “hot”, links to a site that the user wants their recipients to visit and the user's E-mail account that they wish to be contacted by.

In the registration area, apparatus and method for the creation and exchange of data fields of the present invention incorporates proprietary programming to gather the user's name, which will automatically appear in all future templates (“electronic postcard” or Photo-Message). The invention also has a “B1st2Know” program that is initiated by clicking on the “B1st2Know” logo. This provides consumers to contact the initial sender via email or go directly to the sender's website. The user is also automatically contacted by the program of the present invention with a message to confirm that the sender has received their information and will likely be contacted in the near future.

The present invention also allows the consumer to insert text messages onto the “electronic postcard” or “Photo-Message” (the template). The consumer can also e-mail out multiple copies of their template with our program, using addresses that the user imports from their existing files. The present invention program keeps track of the amount of e-mails that the user sends out and notifies them if they have exceeded their limit under their specific marketing plan they have chosen. The program of the present invention also notifies the user in advance of their end due date for their service contract. In addition an automatic extension of the services may be implemented with one click authorization, or through their credit card authorization.

The present invention is directed to a method of sharing and displaying multiple sequenced images, music and text data and subsequently posting the finished templates to another user's (or client's) computer, using an Internet access appliance with Internet telephony and image capture capabilities for commercial and non-commercial use.

The above summary of the present invention is not intended to describe each illustrated embodiment or every implementation of the present invention. The figures and detailed description, which follows, will more particularly exemplify the embodiments.

### DESCRIPTION OF THE DRAWING

The novel features of this invention, as well as the invention itself, both as to its structure, implementation, and its operation, will be best understood from the accompanying drawings, taken in conjunction with the accompanying description, in which reference characters refer to similar parts, and in which:

FIG. 1 is a block diagram of an exemplary apparatus for the creation and exchange of data fields of the present invention showing a host computer system, such as a server, having a data storage device to store digital image, text, and sound data, and a customer computer through which a customer can upload and manage its database within the apparatus for the creation and exchange of data fields with one or more client computers;

FIG. 2 is a representative page showing the Personal Greeting Information page having data fields for the specification of personal greeting information such as telephone numbers, personal message, personal photo, etc., of a referring person, which will be presented to any user each time that user enters the system to remind that user who referred them to the system of the present invention;

FIG. 3 is a representative page showing the Design Choices for the format for the exchange of data using the present invention, including the option of creating a new template from a selection of templates, or using a previous template, and the personal information is displayed on this page;

FIG. 4 is a representative page showing the Choose Your Template option from which a template format can be selected and shown as a template specimen;

FIGS. 5A and 5B are representative pages showing the Template Menu which lists the available templates for the present invention;

FIG. 6 is a representative view of a vertical template and a horizontal template, each having an image field that rotates through a series of images, one or more data fields, and a user image field;

FIG. 7 is a representative page showing the basic format for the creation and sending of a data exchange message, including the Resize Photo operation in Step 1 in which the photos to be inserted into the image field are identified and scaled and/or sized to fit the available image size;

FIG. 8 is a representative page showing the Insert Images operation of Step 2, in which the images are identified by their location on the customer computer, and then transmitted to the host computer for insertion into the data exchange template;

FIG. 9 is a representative page showing the Insert Text operation of Step 3, in which the text for the template header, footer, main text, and user information is input, and then inserted into the data exchange template;

FIG. 10 is a representative page showing the Contact Information operation of Step 4, in which the text for the website link button, the website, E-mail link button, E-mail address and E-Mail subject is input, and then inserted into the data exchange template;

FIG. 11 is a representative page showing the Insert Text operation of Step 4A, in which the text for various header and specific information fields (such as fields for “prices”, “number of bedrooms”,“number of bathrooms”, etc.) may be entered, and then inserted into the data exchange template;

FIG. 12 is a representative page showing the Save And Send operation of Step 5, in which the current template is saved on the server, and where a user may create or add to an existing recipient E-mail List, may send an individualized E-mail of that template, may send multiple E-mails of that template, and where the user may provide helpful suggestions and guidance to the server computer;

FIG. 13 is a representative page showing the Save Template operation of Step 5, in which the user may specify the name of the now-completed template, such as the real property address of “123 Main Street;

FIG. 14 is a representative page showing the Recipient List operation of Step 5, in which the user may make a new list, add a recipient to an existing list, upload an entire E-mail list which will be retained on the server, or may insert an entire E-mail list which will be used for the E-mailing of that template, but then will be subsequently deleted from the server to preserve the confidentiality of the user's proprietary address information;

FIG. 15 is a representative page showing the Send Your Photo-Message operation of Step 5, in which a single E-mail may be sent with a specific message along with the data exchange message;

FIG. 16 is a representative page showing the Select A List To Send E-mail operation of Step 5, in which the user may enter a specific message to be sent to a selected group or list, and provide a specific message along with the data exchange message; and

FIG. 17 is a flow chart representative the operation of the apparatus for the creation and exchange of data fields of the present invention depicting the operation of a preferred embodiment of the present invention.

### DETAILED DESCRIPTION OF A PREFERRED EMBODIMENT

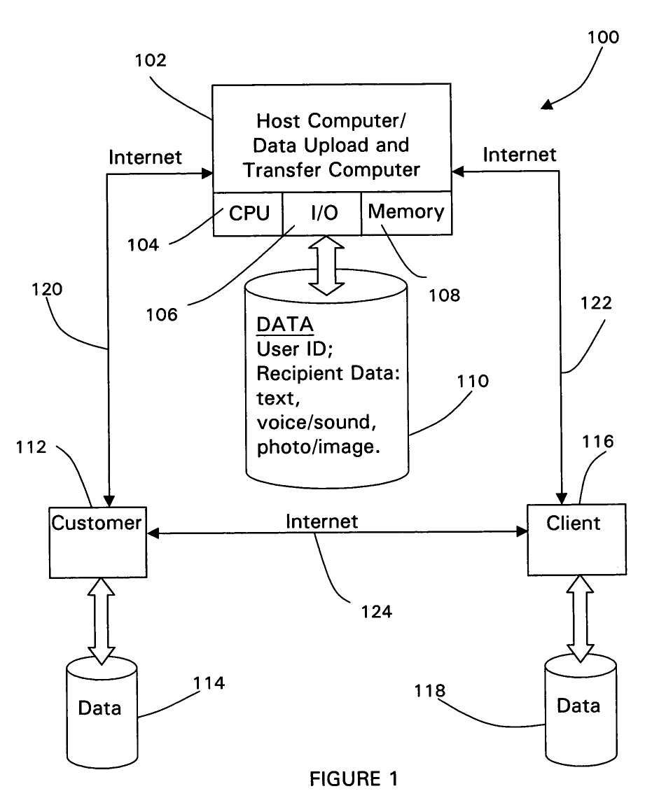

Referring initially to FIG. 1, a block diagram of an exemplary apparatus for the creation and exchange of data fields of the present invention is shown and generally designated 100. System 100 includes a server, or host computer 102, having a central processing unit 104, an input/output device such as a computer display and keyboard, and memory devices 108. In a preferred embodiment, the central processing unit 104 may be a microprocessor, reduced instruction set computer (RISC), or microcontroller. The input/output device may be any device known in the industry and having the ability for a computer user to input data and monitor and control the operation of the host computer or server. Memory 108 may be any digital storage media known in the art, including but not limited to random access memory (RAM), and read only memory (ROM), for example. A data memory device 110 may be provided to host computer 102 to store additional information regarding the users, or customers, such as digital image, text, and sound data.

A customer computer 112 having a memory 114, and a client, or recipient, computer 116 having a memory 118 are connected to the host computer 102 via electronic communications connections 120, 122, and 124. In a preferred embodiment, these connections 120, 122, and 124 may be a global computer network, such as the Internet. In this configuration, data may be exchanged over the connections 120, 122, and 124 using commercially available communications hardware and software as is known in the industry.

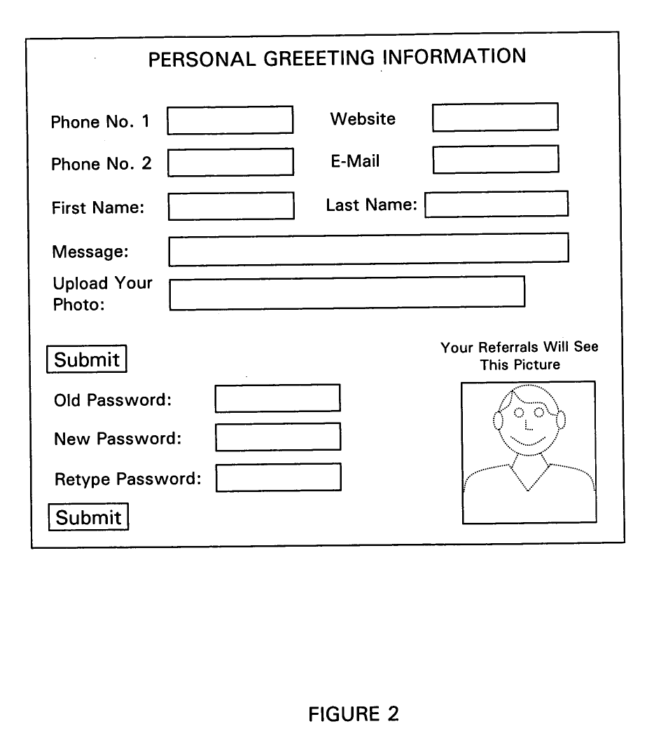

When a user first begins use of the apparatus for the creation and exchange of data fields of the present invention, a Personal Greeting Information page is completed. Referring to FIG. 2, a representative Personal Greeting Information page is shown having data fields for the specification of personal greeting information such as telephone numbers, personal message, personal photo, etc., of a referring person, which will be presented to any user each time that user enters the system to remind that user who referred them to the system of the present invention. It is to be appreciated that this information is merely exemplary, and that additional and/or alternative information may be entered in this format.

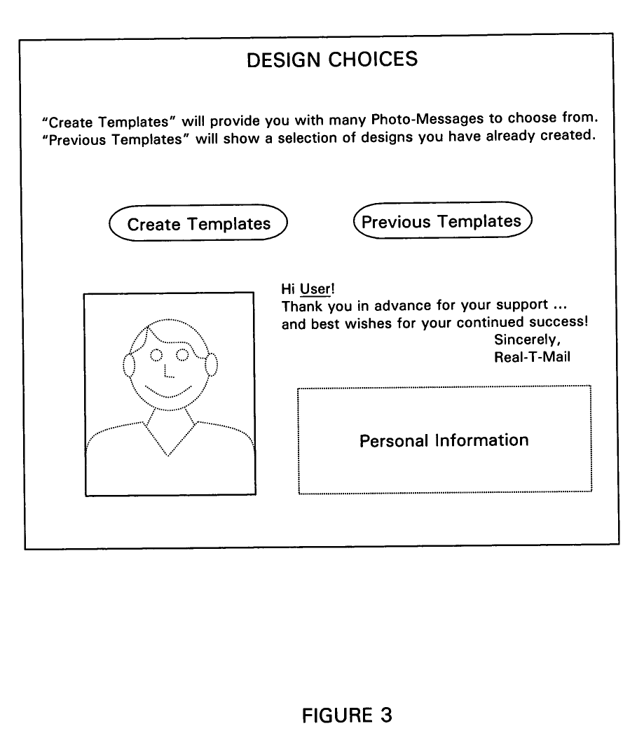

Referring now to FIG. 3, a representative page showing the Design Choices for the format for the exchange of data using the present invention, is shown. The Design Choices page includes the option of creating a new template from a selection of templates, or using a previously created template. The template, once completed will be considered a “data exchange message,” an “electronic postcard”, or a “photo-message.” These three terms are considered to be interchangeable and characterize an electronic message created and transmitted by the present invention.

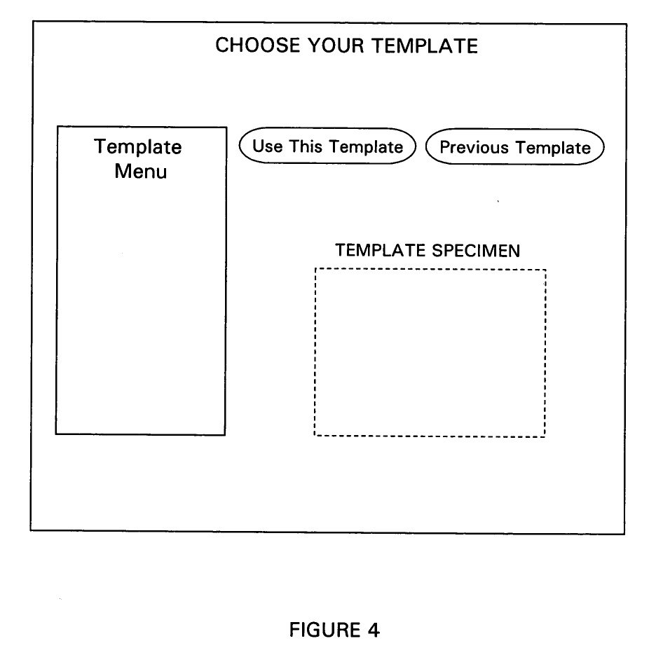

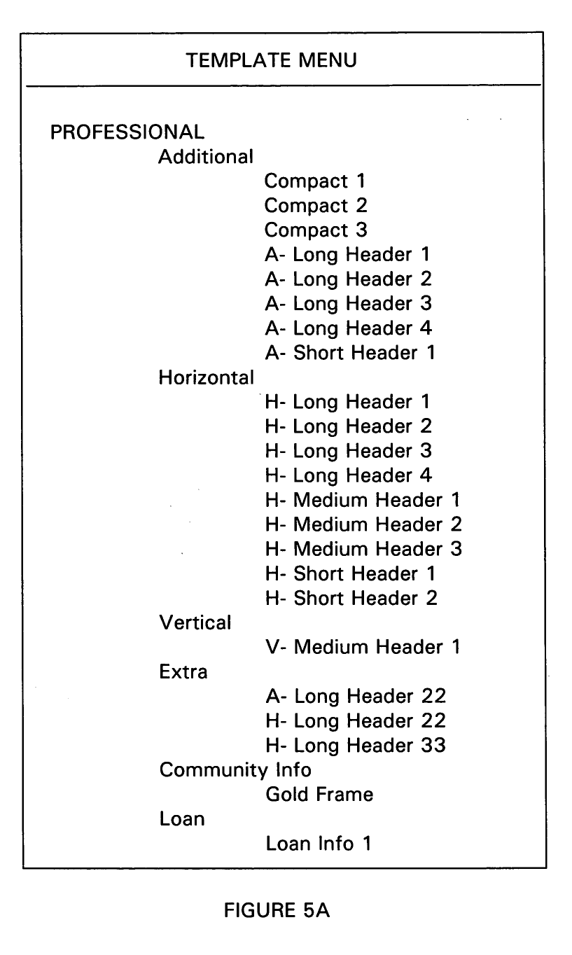

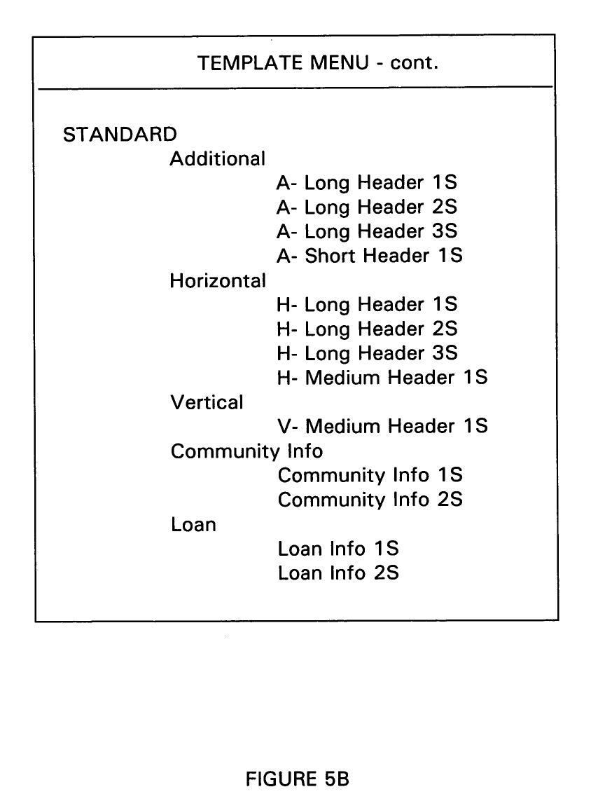

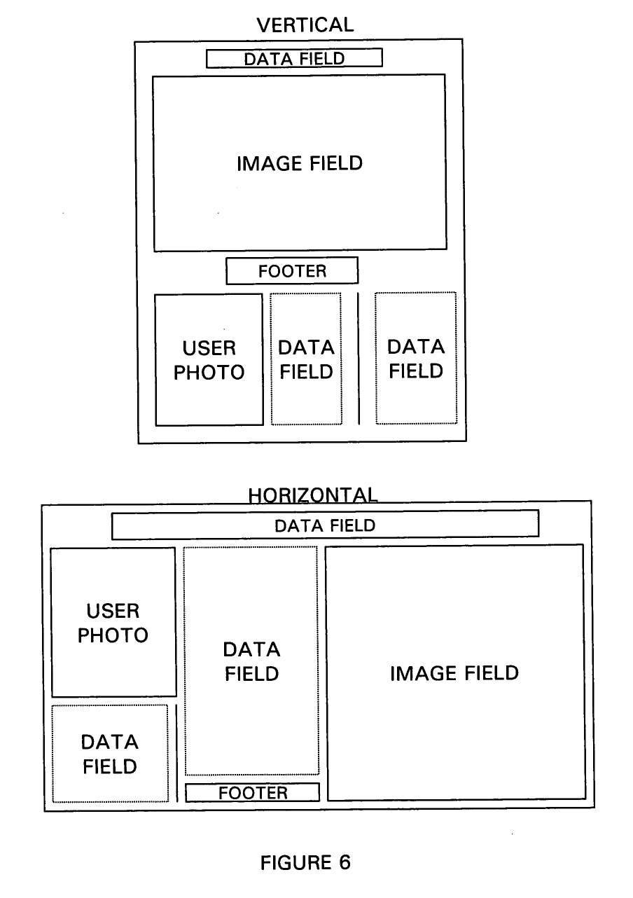

A representative page showing the Choose Your Template option is shown in FIG. 4. From this page, a template format can be selected and shown as a template specimen. For example, referring to FIGS. 5A and 5B, a Template Menu is presented which lists the available templates from which the user may select his or her preferred template. A specimen of the template that is chosen is displayed for the user in order to facilitate the selection of the desired template. FIG. 6 is a representative view of an exemplary vertical template, as well as an exemplary horizontal template. Each of these templates that are shown have an image field through which a series of images will be shown and which are to be uploaded by the user, and at least one or more data fields, and a user image field for a photograph of the user sending the data.

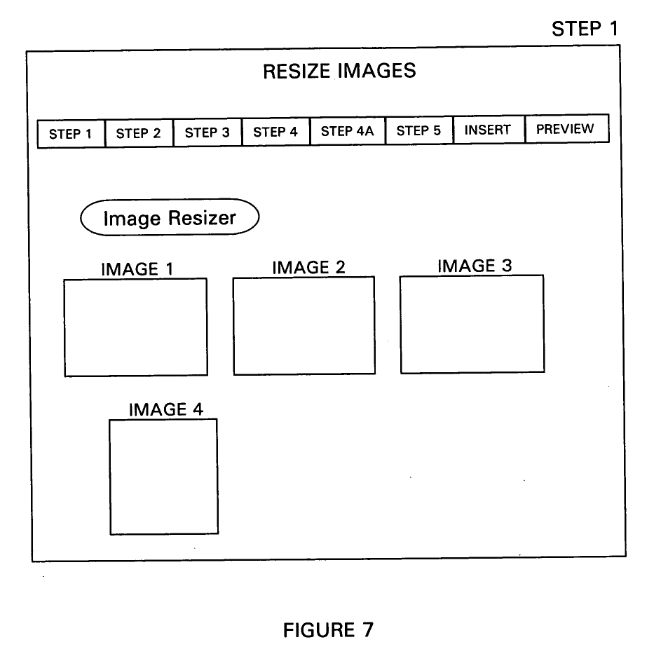

In order for a user to send a data exchange message using the present invention, it is necessary to identify the various images which will be presented through the image field. For example, FIG. 7 is a representative page showing the basic format for the creation and sending of a data exchange message, including the Resize Photo operation in Step 1. In Step 1, the photos to be inserted into the image field are identified and scaled and/or sized to fit the available image size. Once identified, the device of the present invention resizes the images to the appropriate size, and may reduce the resolution of the photo to create a more manageable electronic file size, for easy transmission to one or more customers.

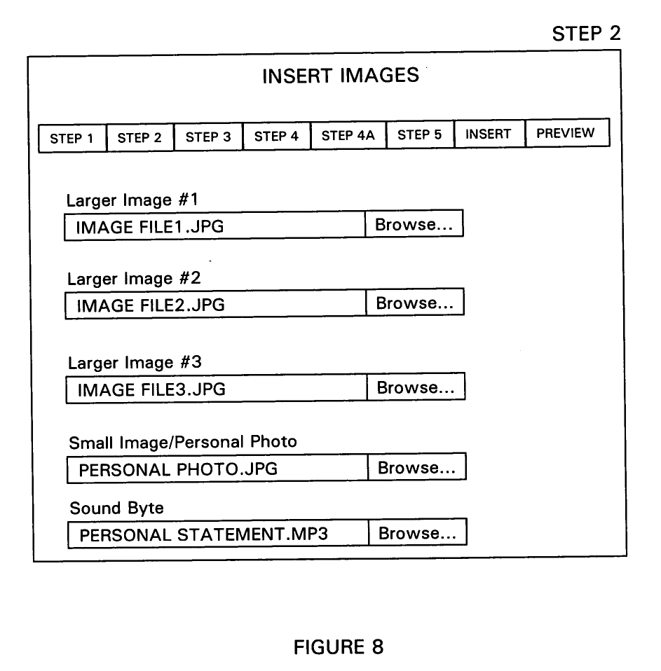

Once the images are selected, FIG. 8 shows a representative page showing the Insert Images operation of Step 2. Step 2 includes the identification of the files by their location on the customer, or users, computer, and these files are uploaded to the host computer to be inserted into the data exchange template.

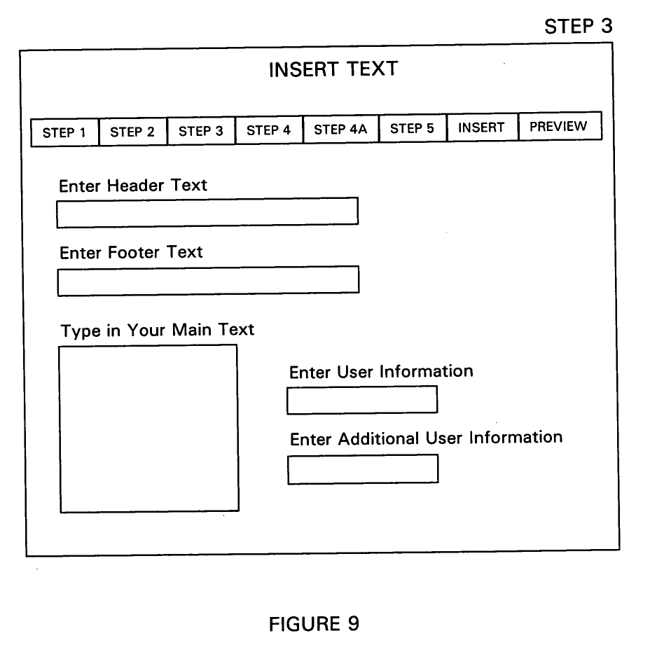

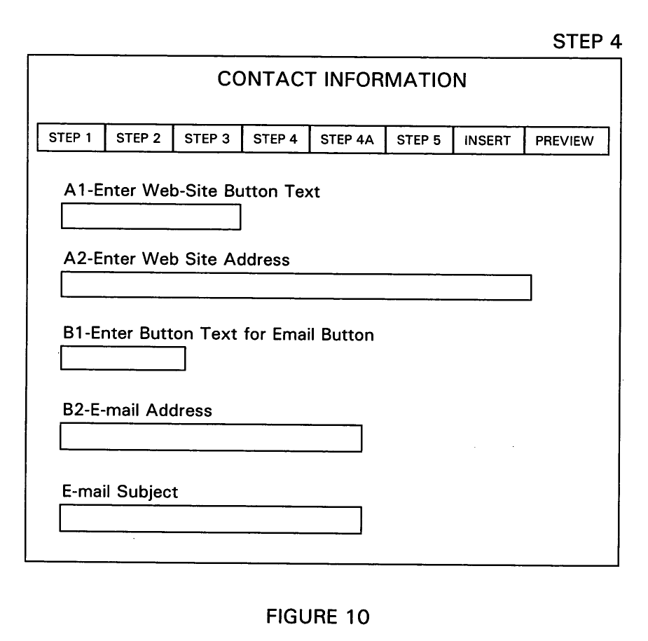

Once the images are selected and uploaded, FIG. 9 shows a representative page showing the Insert Text operation of Step 3. In Step 3, the text for the template header, footer, main text, and user information is input, and then inserted into the data exchange template. Also, in Step 4 shown in FIG. 10, the Contact Information operation allows the insertion of the text for the website link button, the website, E-mail link button, E-mail address and E-Mail subject is input, and then inserted into the data exchange template.

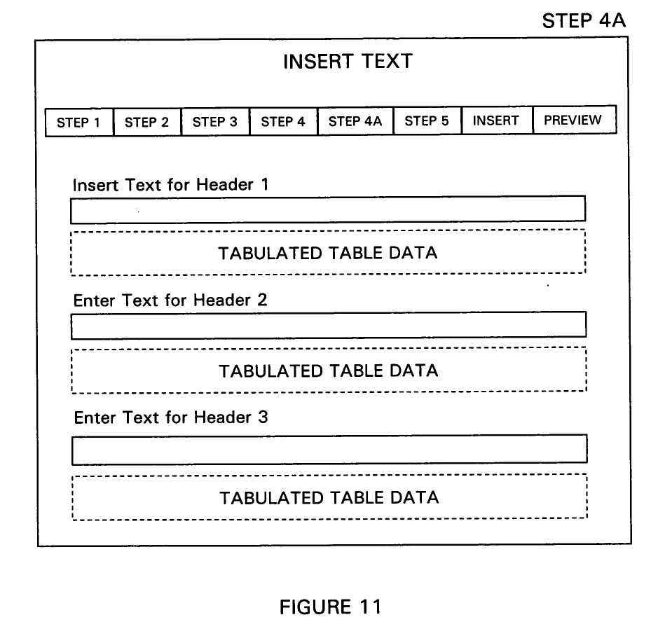

Referring to FIG. 11, a representative page showing the Insert Text operation of Step 4A is presented. In Step 4A, the user may input the text for various header fields, which are then inserted into the data exchange template.

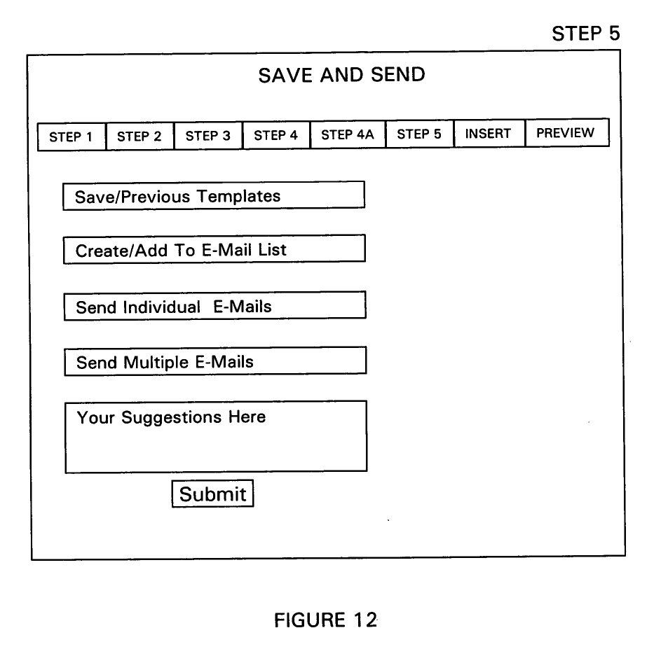

FIG. 12 is a representative page showing the Save And Send operation of Step 5, in which the current template is saved on the server, and where a user may create or add to an existing recipient E-mail List, may send an individualized E-mail of that template may send multiple E-mails of that template, and where the user may provide helpful suggestions and guidance to the server computer.

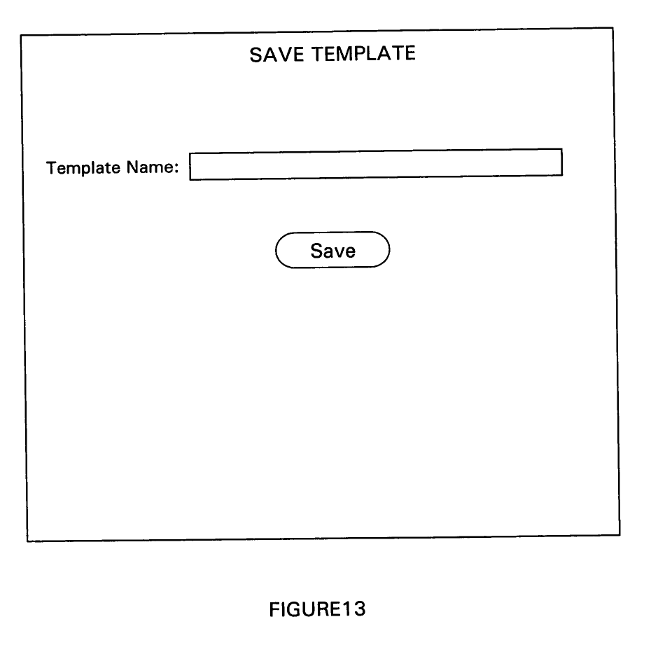

Referring now to FIG. 13, a representative page showing the Save Template operation of Step 5 is presented. In Step 5, the user may specify the name of the now-completed template, such as the real property address of “123 Main Street”.

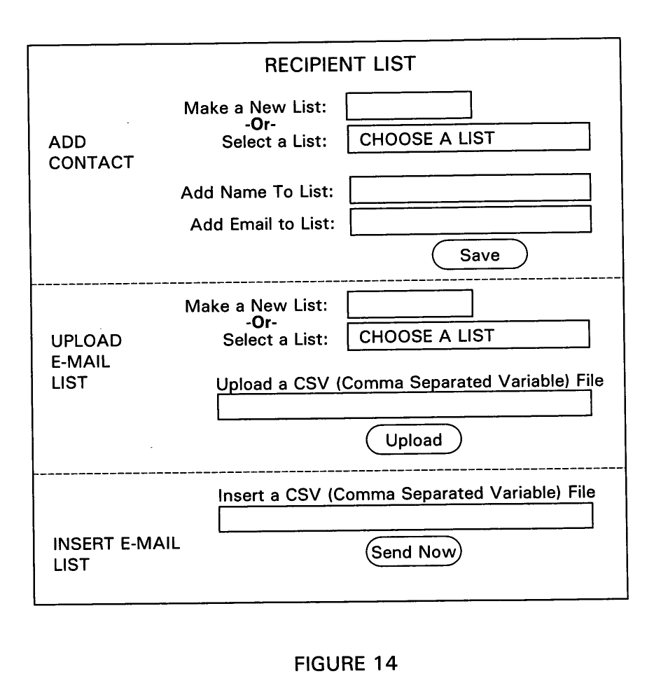

FIG. 14 is a representative page showing the Recipient List operation of Step 5, in which the user may identify the recipient of the E-mails of the template. More specifically, the user may make a new list, add a recipient to an existing recipient list, upload an entire E-mail list which will be retained on the server, or may insert an entire mailing-specific E-mail list which will be used for the E-mailing of that template. When an entire E-mail list is mailing-specific, the list will be subsequently deleted from the server to preserve the confidentiality of the user's address information.

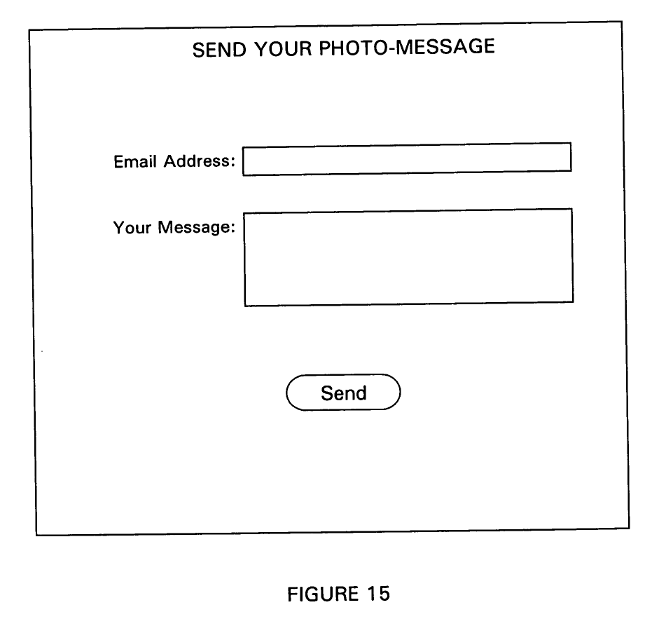

Referring now to FIG. 15, a representative page showing the Send Your Photo-Message (or “electronic postcard”) operation of Step 5 is shown. In this page, a single E-mail may be sent with a specific message along with the data exchange message.

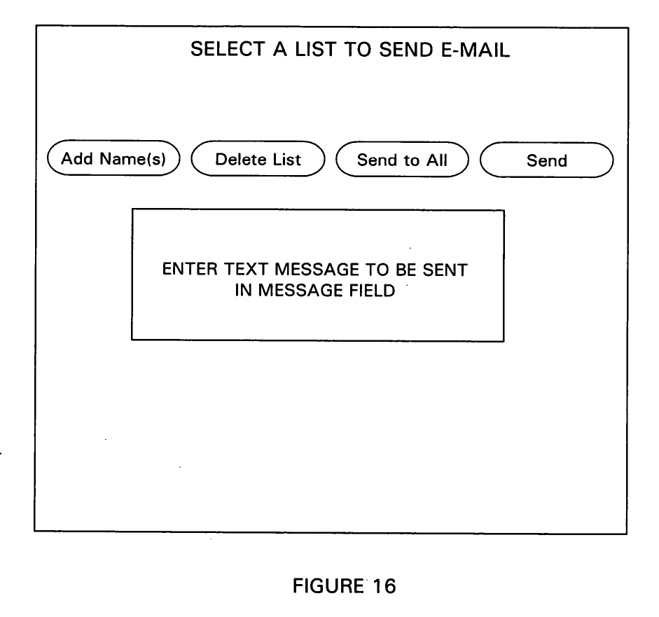

FIG. 16 is a representative page showing the Select A List To Send E-mail operation of Step 5, in which the user may enter a specific message to be sent to a selected group or list, and provide a specific message along with the data exchange message.

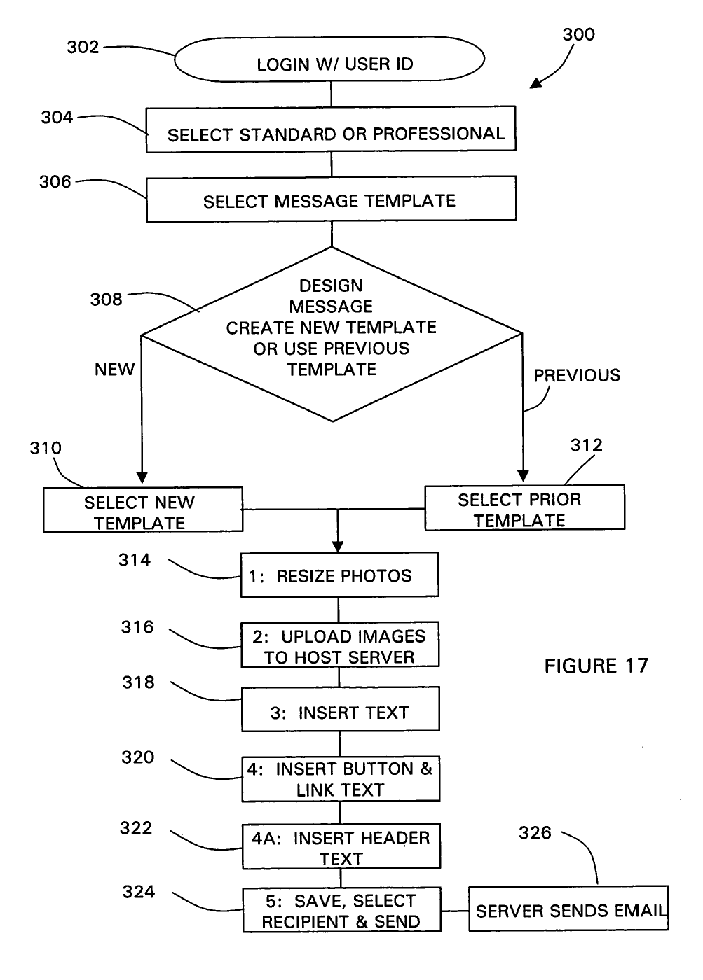

Referring now to FIG. 17, a flow chart representative of the method of operation of the apparatus for the creation and exchange of data fields of the present invention is shown and generally designated 300. The user of the present invention logs into the system with his or her USER ID in step 302. Once access to the system has been achieved, the user is presented with an option to select a “standard” template, or a “professional” template in step 304. The particular template is selected in step 306. In step 308, the system of the present invention provides a user with the ability to design a message template using a new template, or to use a previous template that the user has completed.

In the event that the user has selected a new message template, method 300 passes to step 310 in which a new message template is identified and completed in subsequent steps. On the other hand, if a user selected a prior message template, method 300 passes to step 312 in which the prior message templates are listed, and a prior message template may be retrieved for possible modification.

Once the message template is selected, whether new or previous, the system begins the creation of a data exchange message, and prompts the user to resize his or her images to be uploaded into the template as shown in STEP 1 of FIG. 7. A proprietary image resizing algorithm is available to modify existing image files, such as those digital files in jpeg format, to a size acceptable to the system of the present invention.

Once the photos are selected and re-sized, step 316 in method 300 provides the user the opportunity to upload the image to the host computer to be inserted into the various images fields for the message. This is shown in STEP 2 of FIG. 8. Also, voice or music files may be inserted into the message, or the present invention may provide a listing of available music to be associated with a particular data exchange message.

Method 300 continues to step 318 in which the text of the data exchange message is inserted. This is performed in STEP 3 of FIG. 9, and provides for the entering of the header text, footer text, and any additional user information such as phone number, and E-mail address.

Once the text is inserted into the message template, the button and link text is entered in method step 320. More specifically, by referring to STEP 4 of FIG. 10, the user's contact information is added to the message template, such as the website button text, the website address, the E-mail button text, and the E-mail address.

In Step 4A as shown in FIG. 11, additional text may be entered into the template in method step 322. For instance, text may be inserted into the header sections for the particular message template, as well as data fields may be completed in a tabular format for positioning on the message template.

Following the completion of the entering of photos, sound, and text into the message template, in STEP 5 as shown in FIG. 12, the now-completed message template is saved. In method step 324, the message template is saved to a particular file name on the server as shown in FIG. 13, and the recipients of the message are selected as shown in FIG. 14. More specifically, FIG. 14 depicts an interface providing an opportunity to add a contact to an existing recipient list, upload an entire E-mail list to the server, or insert an entire E-mail list into the message recipient field to be deleted once the message is sent. A comma-separated-variable (CSV) data format is accepted in the present embodiment, however, other known data exchange formats may be accepted without departing from the present invention.

As an alternative, the now-completed message template may be sent to a single E-mail recipient, as depicted in FIG. 15. Once the text, voice, and photographic data has been uploaded into the message template, and the recipients have been selected, the system of the present invention transmits an E-mail message containing the data exchange message containing the now-completed message template as shown in method step 326.

Exemplary Operation of a Preferred Embodiment

The present invention provides a system for displaying and sharing images using an internet access appliance with internet telephony capability. Images are downloaded to an internet access appliance with image capture capability. The images are attached to an electronic communication and sent to a web server via the internet. At the web server the images are parsed and posted to a template on the internet.

Once the template is completed, a second electronic communication is sent from the web server to individuals, selected by the sender of the first electronic communication, via the internet. The selected individuals may comprise family members, friends, target customers, and business associates. The automatic delivery of the second electronic communication provides a highly efficient manner in which the sender of the first electronic communication can communicate with the selected individuals.

Information such as the sender's IP address, email address, web site address, or telephone number may be imbedded into, associated with, or attached to the template. This information provides an easy way for the selected individuals to return a communication efficiently to the sender. In addition, information such as descriptions, prices, and other details may accompany the images (in the template). This accompanying information may be used to describe the images, or list prices of goods for sale, or provide information such as availability and delivery costs.

Selected individuals may visit an additional web page via the internet to view other templates, using an internet access appliance. An individual may click on a posted image with information that is imbedded, associated or attached, thereby initiating further contact.

The present invention greatly enhances communication abilities. For example, the use of this method in the operation of a real estate business broadens the abilities of realtors to communicate with customers, and provides a more cost-effective way to do so. For instance, in an example embodiment of the present invention, a realtor can capture images of real estate property, download them to an internet access appliance and send them to the server where they are imported into a template. Subsequent electronic communication can be sent to potential buyers of the real estate, as selected by the realtor, to inform them of their new listing.

The potential buyers can then access the agent's web site, using an internet access appliance, and view additional real estate images.

Although specific embodiments have been illustrated and described herein, it is appreciated by those of ordinary skill in the art that any arrangement which is calculated to achieve the same purpose may be substituted for the specific embodiments shown. This application is intended to cover any adaptations or variations of the present invention.

Realtor-Data Example

The REAL-T-MAIL™ technology system has two main advantages for Real Estate agents who want to increase their business. It is a great listing tool and it is perfect for agents working with buyers. First of all, the positive benefits of the REAL-T-MAIL™ system for procuring listings is clear. Begin by contacting the agent's previous clients by phone for a quick follow-up and ask permission for their e-mail address. The agent may want to send them a quarterly newsletter and also include a sample of your REAL-T-MAIL Photo-Message™. This marketing innovation will show the prospective customer that the agent is on the cutting edge of technology. The agent may wish to mention to them that they may want to forward this sample on to a friend or business colleague who might be looking for a home. They can use the “Send to a Friend” button to pass it on to multiple recipients. The agent may also consider offering a “referral fee” or “gift reward” for any one who they refer to the agent. This offer for a referral/gift can be typed in the message box found in your Step 5 (Send E-mails) and when it is forwarded to their friend, the text regarding any referral or gift will automatically be removed. The agent's initial recipient can then type a new message in the text box provided and make it personalized to their friend. The benefit to the agent is now you've eliminated having to design, print and pay for B&W or color copies and expensive postage fees. The Photo-Message™ will work perfectly for mass marketing to the agent's farm area by decreasing these expenditures.

Mailing out printed materials for the agent's “just listed”, “price reduced” “market up-date” or “just sold” properties can quickly add-up. With the quick and easy Photo-Message™ of the present invention, an agent can create everything in just minutes and more importantly, have his or her recipients receive the marketing photos and message in just seconds. This will allow the agent to generate more new business by saving time from the old ways of marketing. Remember that time is money and the REAL-T-MAIL™ technology system will save the agent both.

Next is the listing presentation. The agent will most likely have the prospects phone number . . . if the agent doesn't have their email address, call to ask permission from them to send over a sample of how you are marketing for your other clients. They can review just how up to date the agent is with the latest in marketing technologies and feel more confident about the agent's capabilities from the moment he or she walks through the door. People want a true professional who has more to offer than the average competitor. They want the best!

If the agent has the opportunity to visit the property in advance of the presentation, take a few photos so they are available for the appointment and also for the Photo-Message™. If the agent can't acquire the pictures in advance, bring a camera to the presentation and ask permission to take a few photos. Do this only after the agent has established a rapport with the prospective clients. This will allow the agent to have several photo choices for a template design. In the presentation the agent can show the number of e-mail addresses he or she has of other agents and how quickly they can receive your Photo-Message™. People like to know their home will be marketed to other professionals in the fastest time possible.

The REAL-T-MAIL™ technology system will help agents presentation to be stronger and increase his or her ability to get a signed listing. Make sure that the agent sends them a Photo-Message™ even if they are non-committal. This may help to remind them of the agent's capabilities, especially if he or she is in competition with another agent. They need to know that their agent is ready to showcase their home with the latest in state-of-the-art marketing tools.

For Agents working with buyers . . . the REAL-T-MAIL Photo-Message™ is perfect for sharing properties with your clients in advance. It allows them to narrow down the homes they would truly like to see, saving the agent the expense of gas and wasted time. For example: if a buyer has described that they want to see homes that have a pool or a view, send them several Photo-Messages™ so they can see which ones are their preference to look at first. Prospective buyers don't have to go to a web-site and search around for the right page and all the headaches of typing in information. They simply go to their e-mail and click on the camera icon to see the individual properties with multiple photos and concise information.

Because your Photo-Message™ is not an e-mail attachment, it will nearly always appear without being locked-out by anti-spamming software. Each computer is configured differently so some exceptions will apply. Your clients will appreciate your preparation and be excited to see the homes you have pre-selected, that will best suit their needs. This will also give them a good reason to tell their friends and colleagues about the agent's “high-tech” professionalism

Loan Agent Example

The REAL-T-MAIL™ technology site is one of the best new ways of generating loyal loan customers. Let's take a look at the specific features and benefits that are available to loan agents. There are three main reasons a loan agent will achieve outstanding results with the REAL-T-MAIL™ technology system. First, it's the fastest, most economical way of sending multiple photos and information to literally thousands of contacts. A loan agent can send out new rates and financing programs that will keep he and his company fresh in their minds. Provide them with the agent's up-dated rate quotes and new loan programs. The agent can insert company photos of himself or his staff and also include photos of agents who are happy to recommend him to other real estate professionals. Be creative and start increasing the agent's income!

By sharing the agent's exclusive referral number with his clients, he will also be able to have his personal or company photo be seen each time his clients login to their REAL-T-MAIL™ design section. There's also the opportunity to show his e-mail and web-site address. In addition, multiple phone numbers are viewable and all information, including a “Personal Greeting”. Each of these pieces of information is changeable on a daily basis. There is no other marketing tool on the market that provides all these features.

By sending out a Photo-Message™, an agent will be sharing this service to his clients and potential clients. They'll see how it works and how they can use it for their business. This innovative marketing tool will help them showcase their services and their listings. An agent's Photo-Message™ can be sent on a weekly or monthly basis, reaching his entire list of contacts in just seconds.

While the particular apparatus and method for the creation and exchange of data fields as herein shown and disclosed in detail is fully capable of obtaining the objects and providing the advantages herein before stated, it is to be understood that it is merely illustrative of the presently preferred embodiments of the invention and that no limitations are intended to the details of use, implementation, construction or design herein shown other than as described in the appended claims.

What is claimed is:

1. An apparatus for the creation and exchange of data fields, comprising:
a host computer system having a data storage device to store digital image, text, and sound data;
a customer computer having a user-interface through which a customer can upload digital image, text and sound data to said host computer;
a recipient computer;
a means for generating one or more message templates having at least one image and at least one data field; and
a means for exchanging said message template between said host computer and one or more said recipient computer.

2. The apparatus for the creation and exchange of data fields of claim 1, further comprising:
a photo data field having two or more images wherein each said image is displayed in said image field.

3. The apparatus for the creation and exchange of data fields of claim 2, wherein said two or more images are displayed in said image field in sequence.

4. The apparatus for the creation and exchange of data fields of claim 2, further comprising a Personal Greeting Information page having data fields for the specification of personal greeting information.

5. The apparatus for the creation and exchange of data fields of claim 2, further comprising a Design Choices page for selecting the format for the exchange of data.

6. The apparatus for the creation and exchange of data fields of claim 5, wherein said Design Choices pages includes an option of creating a new template from a selection of templates, or using a previous template.

7. The apparatus for the creation and exchange of data fields of claim 2, further comprising a Choose Your Template page from which a template format can be selected and shown as a template specimen.

8. The apparatus for the creation and exchange of data fields of claim 2, further comprising a Template Menu which lists the available templates.

9. The apparatus for the creation and exchange of data fields of claim 2, further comprising a means for resizing photographs to fit the size of said image to said template.

10. The apparatus for the creation and exchange of data fields of claim 2, further comprising an Insert Text page in which the text for a template header, a footer, main text, and user information is input.

11. The apparatus for the creation and exchange of data fields of claim 2, further comprising a Contact Information page in which the text for a website link button, a website, an E-mail link button, E-mail address and E-Mail subject is input.

12. The apparatus for the creation and exchange of data fields of claim 2, further comprising an Insert Text page in which the text for said header and said data fields may be entered.

13. The apparatus for the creation and exchange of data fields of claim 2, further comprising a Save And Send page in which the current template is saved on the server.

14. The apparatus for the creation and exchange of data fields of claim 2, further comprising a means for uploading an recipient E-mail List containing one or more email addresses for said recipients.

15. The apparatus for the creation and exchange of data fields of claim 2, further comprising a Save Template page in which the user may specify the name of the now-completed template.

16. A method of exchanging data fields comprising the steps of:
logging into an apparatus for the creation and exchange of data fields;
selecting a template from a group of “standard” and “professional” template;
designing a message template;
creating a data exchange message having one or more data fields and one or more photo fields;
resizing photo images for insertion into said message template;
inserting the resized images into the message template;
entering text into said data field of said data exchange message;
entering button and link text;
saving the message template to memory;
selecting the recipients of said message template;
transmitting an E-mail message containing said message template containing said data.

17. The method of claim 16, further comprising the step of:
inserting multiple images into said message template.

18. The method of claim 16, further comprising the step of:
inserting a personal photo into said message template.

19. The method of claim 16, further comprising the step of:
playing sound when said message template is received.

20. The method of claim 16, further comprising the step of:
storing said message templates a server to be accessed, edited and re-sent at any time.
